(19) United States
(12) Patent Application Publication
(10) Pub. No.: US 2015/0241017 A1
(43) Pub. Date: Aug. 27, 2015

(54) DEVICE FOR ACTUATING AN OPTICAL ELEMENT OF AN ILLUMINATING AND/OR SIGNALING DEVICE

(71) Applicant: Valeo Vision, Bobigny Cedex (FR)

(72) Inventors: Pierre Albou, Paris (FR); Jean-Claude Puente, Livry Gargan (FR)

(21) Appl. No.: 14/429,962

(22) PCT Filed: Sep. 30, 2013
(86) PCT No.: PCT/EP2013/070342

§ 371 Date: Mar. 20, 2015

(30) Foreign Application Priority Data
Oct. 1, 2012 (FR) 1259246

(51) Int. Cl. F21S 8/10

(52) U.S. Cl. CPC F21S 48/31; F21S 48/145; F21S 48/20; F21S 48/1225; F21S 48/2212; F21S 48/1317; F21S 48/234; F21Y 2101/02

(57) ABSTRACT

Device for actuating at least one optical element of an illuminating and/or signaling device of an automobile, comprising an actuation element arranged so as to displace the optical element under the effect of the energy of rays of the sun, wherein the actuation element comprises an expansible element which deforms under the effect of heat and which is thermally coupled to the optical element, in order to displace the latter when it experiences heating due to the rays of the sun, in order to prevent it from being damaged by the rays of the sun.

The present invention relates to a device for actuating an optical element of an optical module installed in an illuminating and/or signaling device of an automobile. The invention also relates to an optical module comprising such an actuation device, as well as to an illuminating and/or signaling device of an automobile.

More particularly, the invention relates to a new-generation automobile headlamp in which the light source consists of a set of light-emitting diodes (LEDs).

Directional lighting devices, either of the DBL type (Dynamic Bending Light) or with automatic adjustment of the level of the beams of the headlamps as a function of the attitude of the vehicle, or of the LVL category (Leveling Vehicle Light) use headlamps capable of producing an orientable light beam.

Documents FR2760069, FR2770185 or EP1527949 in the name of the Applicant disclose headlamps of this type, in which the reflector, or more generally the light emission module, pivots under the effect of dynamic actuation means as a function of various parameters.

These documents disclose headlamps equipped conventionally with gas discharge lamps, but Document EP1527949 relates to a light emission module comprising at least one light-emitting diode.

Specifically, by virtue of the development of the technology of superluminous light-emitting diodes, or LEDs, these are tending to replace the other types of sources in vehicle headlamps, in view of their high energy efficiency.

Document EP1598593, for example, discloses such an elliptical headlamp with LEDs for vehicles. According to the conventional structure of the optical system of this type of headlamp, the light source is placed at a first focus of the elliptical reflector while a reflective plate, referred to as a “shield” and intended to cut the light beam and ensure distribution of the light energy in the beam according to the standards, is arranged at the second focus. The beam emerging from the mirror is collimated by an aspherical lens, the focal point of which corresponds to this second focus.

One of the advantages of this headlamp over a conventional headlamp is its compactness resulting from the use of LEDs. Unlike the tungsten filament of an incandescent lamp or the gas of a discharge lamp, however, no existing LED withstands a high temperature, for example 200° C.

Now, in certain rare situations resulting from a combination of unusual circumstances, it may happen that the rays of the sun, following a path which is the reverse of that of the beam emitted by an LED, are focused on the chip of the diode, or close thereto, on its housing or on the shield. Likewise, such a situation may cause damage to the shield which, for economic reasons, is made of plastic material and is therefore sensitive to the thermal phenomena.

Similar situations are known in the case of conventional headlamps, the dark parts of which are damaged by the focusing of sunlight.

Under these circumstances, while the effects on a bulb of the sun being aligned on the optical axis of the headlamp are very minor, the LED or the shield is however destroyed by excessive heating.

One known solution to this problem consists in defocusing the light emission modules, but this prevents a maximum luminous efficiency from being reached. Another solution consists in interposing shields, but in this case the optical efficiency of the modules is greatly reduced.

There is therefore a need for a solution to the problem of protecting a headlamp against possible sunlight-induced heating of elements of the headlamp, in particular the light sources and the shields, overcoming the drawbacks of the known devices or methods. More particularly, there is a need for a solution to protect an LED headlamp against the possibility of destruction by sunlight, overcoming the drawbacks of the known devices or methods.

It is more particularly an object of the present invention to solve this problem for an LED headlamp of the type comprising at least one light-emitting diode placed at a first focus of a first optical system intended to form a light beam projected along a first optical path.

According to the invention, the device for actuating at least one optical element of an illuminating and/or signaling device of an automobile comprises an actuation element arranged so as to displace the optical element under the effect of the heat of the rays of the sun. An actuation device is thus obtained which is passive, that is to say not requiring any energy source installed in the vehicle. This makes it possible to keep the actuation device functional even when the vehicle is stationary with the engine off and contact cut, and even when its battery is discharged or removed.

The optical element may comprise a reflector and/or a shield and/or a light source such as a light-emitting diode and/or collimation optics such as a lens.

The actuation element comprises an expansible element which deforms under the effect of heat and which is thermally coupled to the optical element, in order to displace the latter when it experiences heating due to the rays of the sun, in order to prevent it from being damaged by the rays of the sun.

Advantageously, the expansible element comprises a bimetallic strip. A passive actuation element can be produced very simply in this way.

Furthermore, the actuation device may comprise an element for returning the expansible element to a resting position.

The actuation device may comprise a stop defining a resting position.

The actuation device may comprise an element for signaling the position of the optical element.

The optical element may be displaceable in translation, for example in vertical translation or in horizontal translation.

The optical element may be displaceable in rotation.

According to the invention, an optical module of an illuminating and/or signaling device of an automobile comprises one actuation device as defined above.

The module may comprise a light source placed at a first focus of a reflector.

The optical module may comprise an elliptical reflector, a shield located at a second focus of the elliptical reflector and collimation optics, such as a lens, the third focus of which lies at the second focus.

According to the invention, an illuminating and/or signaling device of an automobile, in particular a headlamp, comprises at least one optical module as defined above.

The invention also relates to an automobile comprising an illuminating and/or signaling device as defined above.

The detailed specifications of the invention are given in the description which follows in connection with the appended drawings. It should be noted that these drawings have no purpose other than to illustrate the text of the description and do not in any way constitute a limitation of the scope of the invention.

FIG. 1 is a diagram of one embodiment of a illuminating and/or signaling device according to the invention, represented in a first configuration.

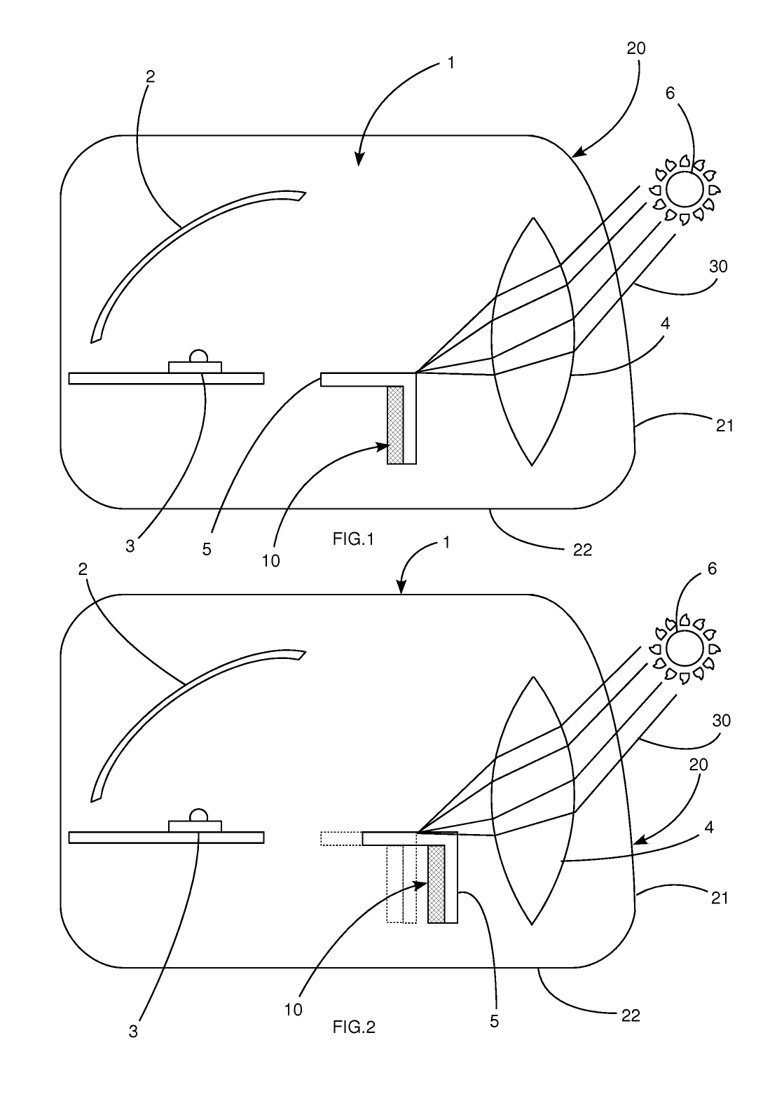

FIG. 2 is a diagram of the embodiment of the illuminating and/or signaling device according to the invention, represented in a second configuration.

FIG. 3 is a diagram of one embodiment of an actuation device according to the invention, represented in a first configuration.

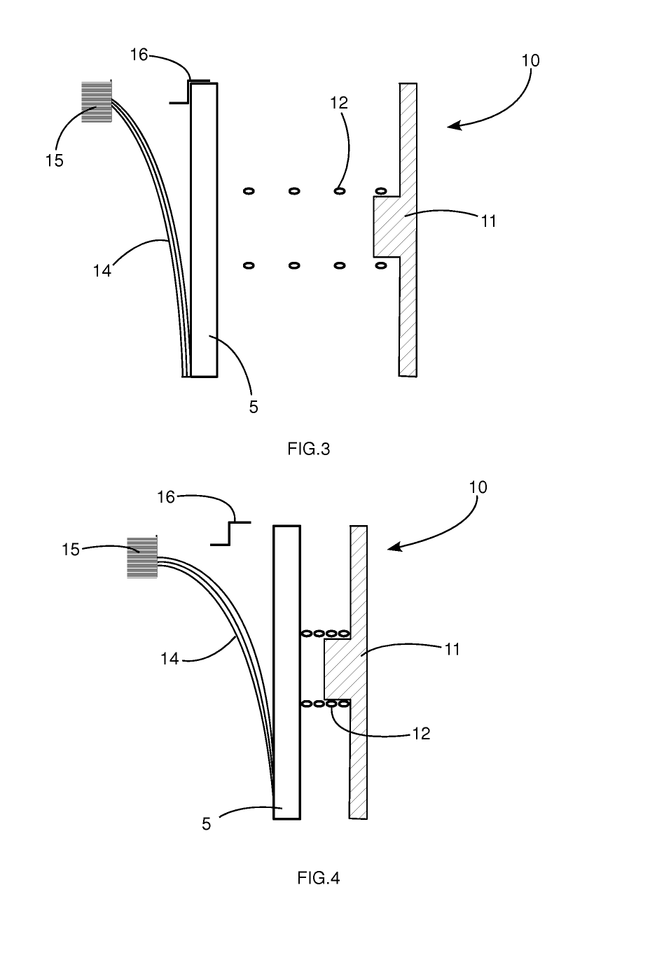

FIG. 4 is a diagram of the embodiment of the actuation device according to the invention, represented in a second configuration.

An embodiment of an illuminating and/or signaling device 20 according to the invention is described below with reference to FIGS. 1 and 2. The device is for example an LED headlamp, in particular an LED headlamp of the LVL category.

The illuminating and/or signaling device 20 comprises at least one optical module 1 and a compartment comprising a housing 22 and an outer lens 21, the optical module 1 being placed in the compartment.

The optical module 1 principally comprises a light source such as a light-emitting diode 3 (or a set of light-emitting diodes), a reflector such as an elliptical mirror 2, collimation optics 4 such as a lens and a shield 5.

The light-emitting diode 3 (or a set of light-emitting diodes) is mounted on a support at a first focus of the elliptical mirror 4. The shield 5 is positioned at the second focus of the elliptical mirror. Likewise, the focus of the collimation optics 4 is positioned at the second focus of the elliptical mirror.

In this way, when the headlamp is on, a light ray emitted by the light-emitting diode 3 is reflected by the mirror 2 then by the shield 5 while following a first optical path. In certain situations (sun low over the horizon and/or vehicle on a hill, reflective street furniture, etc.), even though the headlamp is off the rays of the sun can follow a second optical path which is the reverse of the first optical path, or at least partially. In these situations, if the shield 5 remains in the position of FIG. 1, the rays of the sun risk damaging the shield and/or the light-emitting diode 3, or even destroying it.

Furthermore, as represented in FIGS. 3 and 4, the optical module comprises a device 10 for actuating an optical element 5 of the optical module 1 of the illuminating and/or signaling device 20 of the automobile. In the embodiment described, the optical element is the shield referenced 5. The actuation device comprises an actuation element 14 arranged so as to displace the optical element 5 of the optical module under the effect of the energy of rays of the sun 6. Thus, it is the rays of the sun which, by their heat, control and provide the energy necessary for the displacement of the optical element so that it does not suffer damage due to prolonged exposure to solar radiation.

In order to do this, the actuation element comprises an expansible element 14 which deforms, advantageously only, under the effect of heat and is mechanically and thermally coupled to the optical element. Thus, once the shield 5 is subjected to solar rays 30, converging on the shield 5, as represented in FIG. 1, the shield is heated and some of the energy is absorbed. The shield 5 is initially in the position represented in FIGS. 1 and 3. Some of the thermal energy is transferred from the optical element to the expansible element 14 via the thermal coupling. The expansible element 14 is then deformed and reaches an equilibrium position represented in FIGS. 2 and 4. It follows that the optical element is also displaced. In this new position, the focusing of the rays of the sun no longer presents a risk of damaging the optical element.

In the embodiment of FIGS. 3 and 4, the expansible element 14 comprises a bimetallic strip. The bimetallic strip is fixed, for example at a first end, to a frame 15 consisting for example of a part of the housing 22 or another element of the optical module 1. The bimetallic strip is furthermore fixed, for example at a second end, to the optical element 5.

In the first position of the optical element 5, as represented in FIG. 3, the optical element 5 is returned into contact against a first stop 16 by the action of a resilient restoring element, such as a spring, in particular a coil spring 12, this resilient restoring element bearing on a second stop 11. In this first position, or resting position, the various elements of the optical module are arranged so that the illuminating and/or signaling device operates normally. The expansible element 14 is at rest.

In the second position of the optical element, as represented in FIG. 4, the optical element 5 is returned toward the first stop 16 by the action of the resilient restoring element, but kept in its equilibrium position by the action of the bimetallic strip. This action of the bimetallic strip is determined by its temperature, and therefore by the thermal energy received by the optical element via the rays of the sun. In this second position, or working position, the various elements of the optical module are no longer arranged so that the illuminating and/or signaling device operates normally. Specifically, when the optical element is in this second position, activation of the light source 3 is preferably prevented and/or information is sent to the user of the vehicle in order to indicate to him or her that this activation is not possible or not desirable. In order to fulfill this function, the actuation device 10 may comprise an element for signaling the position of the optical element 5, for example a switch having a first state when the optical element is in the first position and having a second state when the optical element is not in the first position. For example, the switch may be produced by a first contact on the first stop 16 intended to cooperate, that is to say come in contact, with a second contact provided on the optical element 5 when the optical element occupies the first position. This function may also or alternatively be used to control the activation of a device for cooling the mobile optical element, such as a fan, or it may optionally be used to inform the vehicle or the user of the vehicle.

In the embodiment represented, the optical element is mobile or displaceable in translation, particularly in horizontal translation. As an alternative, the optical element may be displaced in vertical translation. As another alternative, the optical element may be displaced in rotation. In order to do this, the actuation device preferably comprises means for guiding the mobile optical element in movement relative to the rest of the optical module. Depending on the nature of the movements, these guide means comprise a slide connection or a pivot connection. The displacement amplitude of the optical element may be limited to just a few millimeters.

In the embodiment described above, the mobile optical element is a shield. In other embodiments, however, the mobile optical element may comprise the reflector 2 and/or the light source 3 and/or the collimation optics and/or a shield which absorbs the light rays, in which case the latter may optionally fulfill the function of cutting the low beam, for example. Also, the mobile optical element may furthermore comprise the shield.

The invention has been described in application to an elliptical optical module. The invention may also be applied to an optical module of the parabolic type. In this case, the optical element may comprise a light source and a parabolic mirror.

In the preferred embodiment described above, the expansible element is a bimetallic strip. The expansible element may, however, be different: it may in particular comprise a cylinder comprising a chamber filled with a substance that expands under the effect of the heat produced by the rays of the sun, in which case this substance may be a gas, a liquid or a wax.

1. A device for actuating at least one optical element of an illuminating and/or signaling device of an automobile, comprising an actuation element arranged so as to displace said at least one optical element under the effect of the energy of rays of the sun, wherein said actuation element comprises an expansible element which deforms under the effect of heat and which is thermally coupled to said at least one optical element, in order to displace the latter when it experiences heating due to the rays of the sun, in order to prevent it from being damaged by the rays of the sun.

2. The device as claimed in claim 1, wherein said at least one optical element comprises a reflector and/or a shield.

3. The device as claimed in claim 1, wherein said at least one optical element comprises a light source such as a light-emitting diode.

4. The device as claimed in claim 1, wherein said at least one optical element comprises collimation optics such as a lens.

5. The device as claimed in claim 1, wherein said expansible element comprises a bimetallic strip.

6. The device as claimed in claim 1, wherein said device comprises an element for returning said expansible element to a resting position.

7. The device as claimed in claim 6, wherein said device comprises a stop defining said resting position.

8. The device as claimed in claim 1, wherein said device comprises an element for signaling the position of said at least one optical element.

9. The device as claimed in claim 1, wherein said at least one optical element is displaceable in translation, for example in vertical translation or in horizontal translation.

10. The device as claimed in claim 1, wherein said at least one optical element is displaceable in rotation.

11. An optical module of said illuminating and/or signaling device of said automobile, comprising said at least one actuation device as claimed in claim 1.

12. The optical module as claimed in claim 11, wherein said optical module comprises a light source placed at a first focus of a reflector.

13. The optical module as claimed in claim 12, wherein the reflector is elliptical, and wherein said optical module comprises a shield located at a second focus of said reflector and collimation optics, such as a lens, the third focus of which lies at said second focus.

14. An illuminating and/or signaling device of said automobile, in particular a headlamp, comprising said optical module as claimed in claim 11.

15. An illuminating and/or signaling device of said automobile, in particular a headlamp, comprising said optical module as claimed in claim 12.

16. An illuminating and/or signaling device of said automobile, in particular a headlamp, comprising said optical module as claimed in claim 13.

17. The device as claimed in claim 2, wherein said at least one optical element comprises a light source such as a light-emitting diode.

18. The device as claimed in claim 17, wherein said at least one optical element comprises collimation optics such as a lens.

19. The device as claimed in claim 2, wherein said expansible element comprises a bimetallic strip.

20. The device as claimed in claim 17, wherein said expansible element comprises a bimetallic strip.
